(19) United States
(12) Patent Application Publication
(10) Pub. No.: US 2018/0268218 A1
(43) Pub. Date: Sep. 20, 2018

(54) INFORMATION DISPLAY SYSTEM

(71) Applicant: DENSO WAVE INCORPORATED, Chita-gun (JP)

(72) Inventor: Kazunori WATANABE, Chita-gun (JP)

(73) Assignee: DENSO WAVE INCORPORATED, Chita-gun, Aichi-pref. (JP)

(21) Appl. No.: 15/921,099

(22) Filed: Mar. 14, 2018

(30) Foreign Application Priority Data
Mar. 17, 2017 (JP) 2017-052713

(51) Int. Cl. G06K 9/00; G06T 19/00; G06F 3/147; G02B 27/01

(52) U.S. Cl. CPC G06K 9/00671; G06T 19/006; G08B 21/02; G02B 27/0172; G06F 3/147

(57) ABSTRACT

In an information display system, a wearable display displays information within a field of view of the user. Monitoring target information related to a monitoring target is acquired. Field-of-view information for identifying the field of view of a user is acquired. The monitoring target present within the field of view of the user is identified based on the acquired field-of-view information. A display control unit displays, within the field of view of the user, a symbol display that indicates that the monitoring target information is present when the monitoring target information regarding the monitoring target captured within the field of view of the user is present, and displays, within the field of view of the user, the monitoring target information corresponding to the symbol display when an aim display set within the field of view of the user overlaps the symbol display within the field of view of the user.

### CROSS-REFERENCE TO RELATED APPLICATION

This application is based on and claims the benefit of priority from earlier Japanese Patent Application No. 2017-052713, filed Mar. 17, 2017, the description of which is incorporated herein by reference.

### BACKGROUND

### Technical Field

The present disclosure relates to an information display system that displays, within a field of view of a user, information related to a monitoring target through a type of display that is worn on a head portion of the user.

### Related Art

In recent years, a technology has been proposed in which, for example, virtual-reality images and various types of information are displayed through use of a so-called head-mounted display (referred to, hereafter, as an HMD) that can be worn on a head of a user (see, for example, JP-A-2015-228201). As application of this technology, the following can be supposed. For example, to present information related to safety regarding a robot or a carrier vehicle to a user who is working within or near an operating area of the robot or the carrier vehicle, the information related to safety is displayed in an HMD that is worn by the user. As a result, the user is able to acquire the information related to safety regarding the robot or the carrier vehicle while keeping their gaze raised, without having to peer into a teaching pendant, a tablet terminal, or the like. Consequently, improvement in safety is achieved.

However, most typical HMDs are configured such that a transparent-type display unit is arranged in a location that overlaps the field of view of the user and various types of information are displayed in the display unit. In this case, the information displayed in the display unit and an actual view seen by the user through the display unit overlap. Therefore, for example, in cases in which a plurality of robots or carrier vehicle are present, should information on all of the robots or carrier vehicles be simultaneously displayed within the field of view of the user, the field of view of the user becomes obstructed. Furthermore, when the field of view becomes obstructed as a result of the information related to the robots or carrier vehicles being displayed regardless of the user not paying attention to the robots or carrier vehicles within the field of view, an unexpected situation, such as the user colliding with a robot or a carrier vehicle to which the user is not paying attention, may occur. Consequently, in some cases, decrease in safety may instead become a concern.

### SUMMARY

It is thus desired to provide an information display system that presents a user with information using a wearable display and enables safe information presentation.

An exemplary embodiment of the present disclosure provides an information display system that includes: a wearable display that is worn by a user and displays information within a field of view of the user; a monitoring target information acquiring unit that acquires monitoring target information that is information related to a monitoring target; a field-of-view information acquiring unit that acquires field-of-view information for identifying the field of view of the user; a monitoring target identifying unit that identifies the monitoring target present within the field of view of the user based on the field-of-view information acquired by the field-of-view information acquiring unit; and a display control unit that displays, within the field of view of the user, a symbol display that indicates that the monitoring target information is present when the monitoring target information regarding the monitoring target captured within the field of view of the user is present, and displays, within the field of view of the user, the monitoring target information corresponding to the symbol display when an aim display within the field of view of the user overlaps the symbol display within the field of view of the user.

As a result, the user can confirm whether or not the monitoring target information regarding the monitoring target captured within their field of view is present by confirming the symbol display displayed within the field of view. In addition, the user can display the monitoring target information corresponding to the symbol display within the field of view by changing the orientation of their head, that is, their line of sight and moving the field of view, and thereby overlapping the aim display set within the field of view with the symbol display within the field of view. That is, the user can display the monitoring target information within the field of view by performing an operation to aim their line of sight onto the symbol display corresponding to the monitoring target information to be displayed. Therefore, even when a plurality of monitoring targets are captured within the field of view, numerous pieces of monitoring target information are not simultaneously displayed within the field of view. The field of view of the user is not obstructed.

In addition, as a result of this configuration, unless the user indicates an intention to view the monitoring target information regarding the monitoring target within the field of view by taking an action, that is, by moving their line of sight and overlapping the aim display with the symbol display, the monitoring target information that occupies and blocks the field of view of the user is not displayed within the field of view. Therefore, as a result of this configuration, a situation in which the monitoring target information is displayed within the field of view and the field of view becomes blocked regardless of the intention of the user can be prevented to the greatest possible extent.

Furthermore, as a result of the user moving their line of sight and overlapping the aim display with the symbol display, the attention of the user is inevitably given to the symbol display and further, the monitoring target corresponding to the symbol display. As a result, the field of view becoming blocked by the monitoring target information related to a monitoring target to which the user is not paying attention, regardless of the attention of the user not being given to the monitoring target within the field of view can be prevented. Therefore, as a result of the present configuration, the field of view becoming filled as a result of a plurality of pieces of monitoring target information being displayed, and the monitoring target information related to a monitoring target regardless of the attention of the user not being given to the monitoring target can be prevented. Consequently, a safe information presentation in which the field of view of the user is not obstructed can be achieved.

In the present disclosure, the display control unit may visibly displays the aim display within the field of view of the user. Therefore, the user can overlap the aim display and the symbol display while visually confirming the aim display and the symbol display. As a result, the user can easily overlap the aim display and the symbol display. Consequently, operability is improved.

Here, a following case can be supposed. That is, for example, the user may move the field of view in accompaniment with an ordinary operation, rather than moving the field of view to view the monitoring target information. The aim display and the symbol display may overlap within the field of view, counter to the intentions of the user. In this case, when the user moves the field of view during an ordinary operation, should the monitoring target information be displayed within the field of view, counter to the intentions of the user, simply because the aim display passes over and temporarily overlaps the symbol display within the field of view, the field of view is instead obstructed.

Therefore, in the present disclosure, the display control unit may display the monitoring target information after elapse of a predetermined period from when the aim display starts to overlap the symbol display.

As a result, the monitoring target information is displayed within the field of view only when the user overlaps and views the aim display and the symbol display for a predetermined period or longer, that is, the user indicates a clear intent to overlap the aim display and the symbol display. In other words, as a result, the monitoring target information being displayed within the field of view simply because the aim display passes over and temporarily overlaps the symbol display within the field of view can be prevented. Consequently, a safer information presentation in which the field of view of the user is further less easily obstructed can be achieved.

In the present disclosure, the display control unit may display, when the aim display overlaps the symbol display within the field of view of the user, the symbol display that overlaps the aim display in a manner differing from that when the aim display does not overlap the symbol display. As a result, the user can confirm whether or not the aim display overlaps the symbol display by seeing whether or not the display aspect of the symbol display has changed.

That is, under an assumption of a state before the monitoring target information is displayed, the user can visually confirm whether or not the aim display overlaps the symbol display by seeing a change in the display aspect of the symbol display. In addition, in cases in which a plurality of monitoring targets are captured within the field of view, the user can visually confirm the symbol display corresponding to the monitoring target information that the user wishes to view, by seeing the symbol display of which the display aspect has changed.

Furthermore, under an assumption of a state after the monitoring target information is displayed, in cases in which a plurality of monitoring targets are captured within the field of view, the symbol display that corresponds to the monitoring target information that is being displayed is displayed in a manner differing from that of other symbol displays of which the monitoring target information is not being displayed. Therefore, even in cases in which a plurality of monitoring targets are captured within the field of view and a plurality of symbol displays are displayed within the field of view, the user can confirm, at a glance, the symbol display within the field of view that corresponds to the monitoring target information currently being displayed, by seeing the symbol display that is being displayed in an aspect that differs from that of the other symbol displays. Consequently, confirmation by the user is facilitated and an even safer information presentation can be achieved.

In the present disclosure, the display control unit may display a non-transparent display area within the field of view of the user and displays the monitoring target information within the display area. Therefore, as a result of the monitoring target information being displayed within the non-transparent display area, the monitoring target information that is displayed within the display area can be prevented from blending with the actual scene in the background of the display area. As a result, the monitoring target information can be made more easily visible. Consequently, an even safer information presentation can be achieved.

Here, for example, when the user moves to another location, the user often looks over a distance to where the destination is located. A monitoring target that is at a far-off distance appears small within the field of view. Therefore, while moving to another location, the user is unlikely to be watching the monitoring target itself. However, a following case may be considered. That is, when the user who is moving while looking towards the destination moves their line of sight, the aim display may inadvertently overlap the symbol display corresponding to a far-off monitoring target. In this case, when the monitoring target information is displayed within the field of view counter to the intentions of the user, the field of view of the user who is moving becomes blocked. Therefore, decrease in safety instead becomes a concern.

Therefore, in the present disclosure, the display control unit may not display the monitoring target information within the field of view of the user regarding the monitoring target that is separated from the user by a predetermined distance or more, among the monitoring targets captured within the field of view of the user, even when the aim display overlaps the symbol display. Alternatively, the display control unit may not display the symbol display within the field of view of the user regarding the monitoring target that is separated from the user by a predetermined distance or more, among the monitoring targets captured within the field of view of the user.

Therefore, even when the aim display coincidentally overlaps the symbol display corresponding to the monitoring target that is at a far-off distance within the field of view of the user who is moving to another location, the monitoring target information corresponding to the symbol display is not displayed within the field of view. Alternatively, the display control unit does not display the symbol display itself when the monitoring target is present at a far-off distance. As a result, the aim display does not overlap the symbol display and therefore, the monitoring target information related to the far-off monitoring target is also not displayed within the field of view. As a result, for example, even when the user who is moving to another location captures a far-off monitoring target within the field of view, the monitoring target information regarding the far-off monitoring target is not displayed. Therefore, blocking of the field of view of the user who is moving to another location can be reduced. Consequently, safety can be further improved.

### BRIEF DESCRIPTION OF THE DRAWINGS

In the accompanying drawings:

FIG. 1 is a diagram schematically showing an overall configuration of an information display system according to an embodiment;

FIG. 2 is a block diagram schematically showing an electrical configuration of the information display system according to the embodiment;

FIG. 3 is a diagram of an example of a field of view visible to a user through a display unit in a case in which a monitoring target is captured within the field of view, according to the embodiment;

FIG. 4 is a diagram of an example of the field of view visible to the user through the display unit in a state in which an aim display and a first symbol display overlap within the field of view, according to the embodiment;

FIG. 5 is a diagram of an example of the field of view visible to the user through the display unit in a state in which first monitoring target information is displayed within the field of view, according to the embodiment;

FIG. 6 is a diagram of an example of the field of view visible to the user through the display unit in a state in which the aim display and a second symbol display overlap within the field of view, according to the embodiment;

FIG. 7 is a diagram of an example of the field of view visible to the user through the display unit in which second monitoring target information is displayed within the field of view, according to the embodiment;

FIG. 8 is a diagram of an example of the field of view visible to the user through the display unit in a case in which a far-off monitoring target is captured within the field of view, according to the embodiment; and

FIG. 9 is a flowchart of the content of a process performed by a control unit of a display control apparatus according to the embodiment.

### DESCRIPTION OF THE EMBODIMENTS

An embodiment will hereinafter be described with reference to the drawings.

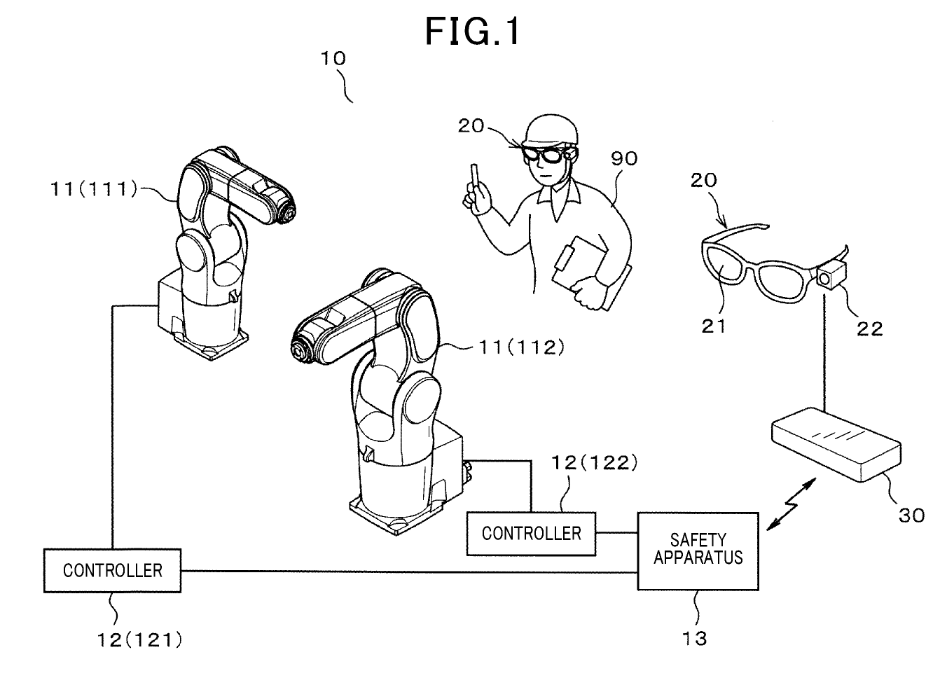

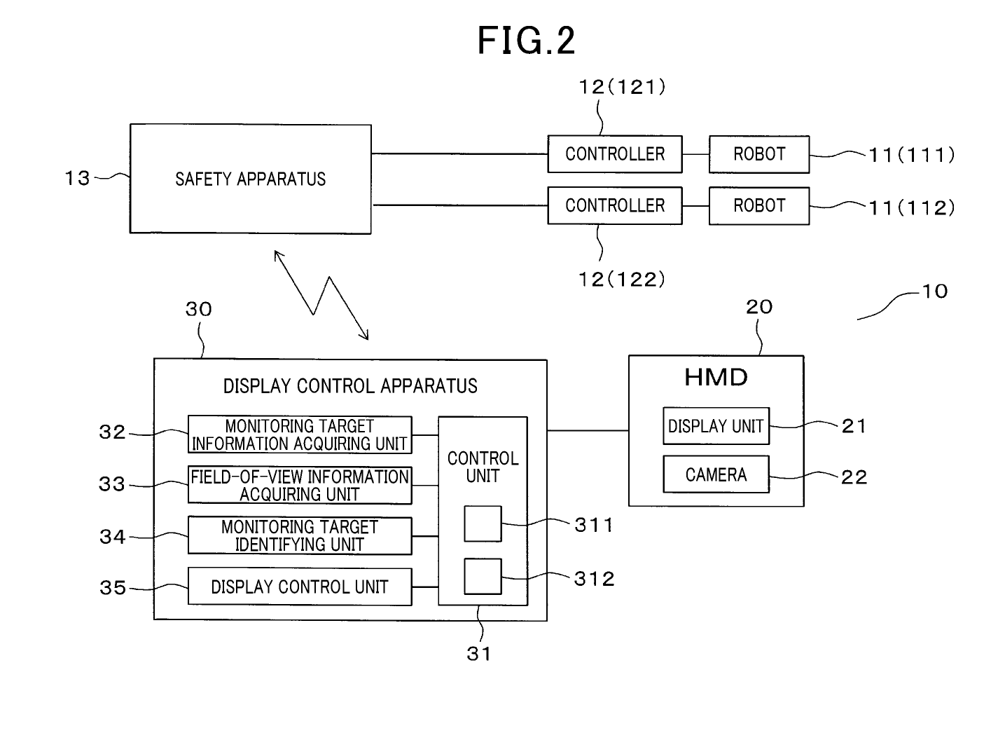

As shown in FIGS. 1 and 2, an information display system 10 is configured to include at least a single robot 11 (two robots 11 according to the present embodiment), a robot controller 12, a safety apparatus 13, a so-called head-mounted display 20 (referred to, hereafter, as an HMD 20), and a display control apparatus 30. The robot 11 is a monitoring target. The robot controller 12 is provided respectively for each robot 11.

In the description below, the two robots 11 are referred to as a first robot 111 and a second robot 112 when differentiation therebetween is made. In addition, the robot controllers 12 corresponding to the first robot 111 and the second robot 112 are respectively referred to as a first robot controller 121 and a second robot controller 122.

For example, the robot 11 is configured by a six-axis vertical articulated robot. The robot 11 has a typical configuration. Therefore, a detailed description thereof will be omitted. The robot 11 has a six-axis arm that is driven by servomotors. A hand or the like is provided at a tip end portion of the sixth-axis arm. For example, the hand is used to grip a workpiece that is housed in a pallet. The robot 11 is connected to the robot controller 12 by a connection cable (not shown). The servomotor of each axis is controlled by the robot controller 12.

Each robot controller 12 is communicably connected to the safety apparatus 13. The safety apparatus 13 is configured to acquire, from the robot controller 12 side, various types of information that enable identification of an operation state of each robot 11 and a control state of each robot controller 12. Therefore, the safety apparatus 13 acquires, in real-time, operation information indicating the operation state of the robot 11 and control information indicating the control state of the robot controller 12. For example, the safety apparatus 13 acquires operation information such as a rotation angle of the arm of the robot 11 and an energization state of the motors.

In addition, the safety apparatus 13 generates three-dimensional (3D) model image data based on the information on the robot 11 acquired from the robot controller 12. The 3D model image data expresses a current form, that is, attitude of the robot 11 modeled in 3D. Furthermore, the safety apparatus 13 also stores coordinates of each robot 11 on a two-dimensional coordinate system of which a point of origin is an area in which the robot 11 is set, such as a reference position within a factory. That is, the safety apparatus 12 stores a setup position of the robot 11.

The HMD 20 is configured to be shaped so as to be wearable on a head portion of a user. The HMD 20 displays various types of information within a field of view of the user.

The HMD 20 may be either of a binocular type in which both eyes are covered and a monocular type in which only either eye is covered. However, according to the present embodiment, the HMD 20 is more suitable as the binocular type that tends to take over the field of view of the user. In addition, as the shape of the HMD 20, a glasses type that is worn in a manner similar to eyeglasses, a hat type that is worn in a manner similar to a hat, and the like are supposed. However, the HMD 20 may be of any shape. The HMD 20 according to the present embodiment is assumed to be the glasses type.

As also shown in FIG. 2, the HMD 20 has a display unit 21 and a camera 22. The display unit 21 is provided in a position that overlaps the field of view of the user in a state in which the user is wearing the HMD 20. According to the present embodiment, the display unit 21 is a portion that corresponds to a lens portion of the eyeglasses. The display unit 21 is configured by a so-called transparent-type display that displays information such as images. Therefore, an image that is displayed in the HMD 20 is displayed so as to overlap the field of view of the user. In other words, the user sees both an actual scene as seen through the eyes of the user themselves and a virtual image displayed in the HMD 20.

The camera 22 is configured by a compact charge-coupled device (CCD) camera or complementary metal-oxide-semiconductor (CMOS) camera. The camera 22 is integrally attached to the HMD 20. The camera 22 is provided in one side portion of a frame of the HMD 20 so as to coincide with the orientation of the face of the user. As shown in FIG. 1, the camera 22 captures an image in a direction in which the front of the head portion of a user 90 is facing, in a state in which the user 90 is wearing the HMD 20 on their head. Therefore, the image captured by the camera 22 has substantially the same angle of view as the field of view of the user 90. In other words, the camera 22 captures substantially the same scene as that seen by the user 90.

The display unit 21 is not limited to the transparent-type display and may be configured by a non-transparent type display. In this case, as a result of the image captured by the camera 22 being displayed in real-time in the display unit 21, the HMD 20 may virtually present the user with the scene captured by the camera 22. That is, the HMD 20 may reproduce the field of view of the user in the display unit 21. In addition, the HMD 20 is not limited to that which includes the display unit 21. The HMD 20 may be a retinal-projection type that directly projects a virtual image onto the retina of the user.

The HMD 20 is connected to the display control apparatus 30 by wireless or wired connection. The display control apparatus 30 may be integrally configured with the HMD 20. As shown in FIG. 2, a control unit 31 is provided within the display control apparatus 30. The control unit 31 is configured by a microcomputer or the like. The display control apparatus 30 transmits image data to be displayed in the display unit 21 of the HMD 20 and receives image data picked up by the camera 22. In addition, the display control apparatus 30 communicates with the safety apparatus 13 by wired or wireless communication.

As shown in FIG. 2, the display control apparatus 30 includes, in addition to the control unit 31, a monitoring target information acquiring unit 32, a field-of-view information acquiring unit 33, a monitoring target identifying unit 34, and a display control unit 35. The control unit 31 is mainly configured by a microcomputer that includes, for example, a central processing unit (CPU) 311 and a storage area 312 such as a read-only memory (ROM), a random access memory (RAM), and a rewritable flash memory. The control unit 31 performs control of the overall HMD 20.

The storage area 312 stores therein an information display program. The control unit 31 actualizes, through software, the monitoring target information acquiring unit 32, the field-of-view information acquiring unit 33, the monitoring target identifying unit 34, the display control unit 35, and the like as a result of the CPU 311 running the information display program. The monitoring target information acquiring unit 32, the field-of-view information acquiring unit 33, the monitoring target identifying unit 34, and the display control unit 35 may be actualized by hardware, such as an integrated circuit that is integrated with the control unit 31.

The monitoring target information acquiring unit 32 acquires monitoring target information from the safety apparatus 13 in real-time, as information related to the robot 11 that is the monitoring target. The monitoring target information is composed of pieces of information that continually change based on the operation of the robot 11. For example, the monitoring target information includes the operation information indicating the operation state of the robot 11, including the above-described 3D model image data, and the control information indicating the control state of the robot controller 12. In addition, for example, the monitoring target information also includes alert and warning information for presenting the user with alerts and warnings related to the robot 11.

In addition, the monitoring target information acquiring unit 32 acquires a distance between the robot 11 and the user 90, for each robot 11 that is the monitoring target. For example, the monitoring target information acquiring unit 32 acquires the distance between the robot 11 and the user 90 based on positional information of the robot 11 and positional information of the user 90. The positional information of the user 90 is acquired by a compact global positioning system (GPS) being provided in the HMD 20 that is worn by the user 90 or the display control apparatus 30 that is carried by the user 90. In addition, instead of the positional information of the user 90 being acquired as a result of the position of the user 90 being directly identified by the GPS unit or the like, the following configuration is also possible. That is, for example, a movement trajectory of the user 90 from a reference position, such as an entrance to a factory, may be acquired. The position of the user 90 may be indirectly identified based on an amount of displacement from the reference position.

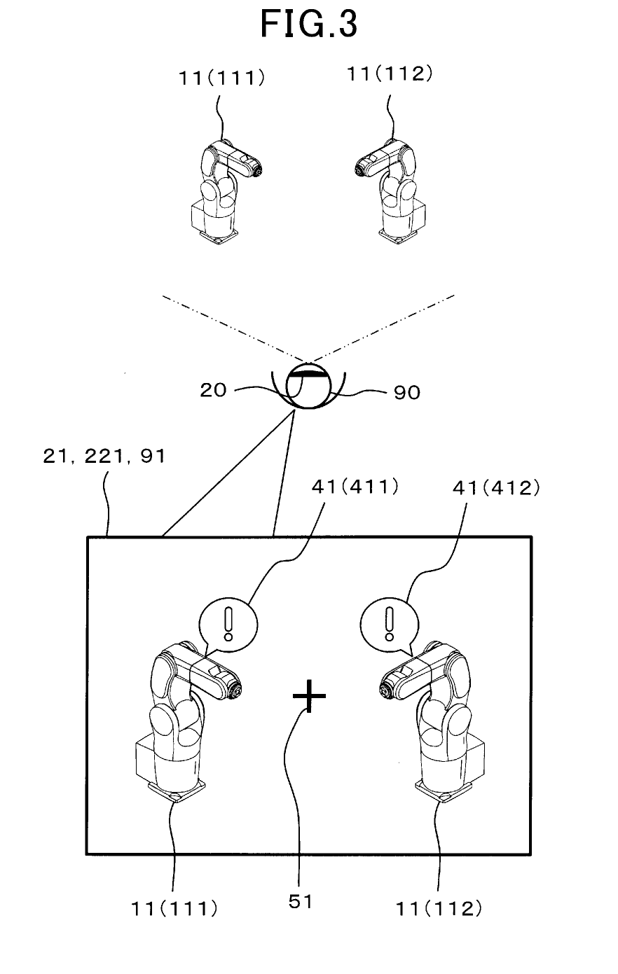

The field-of-view information acquiring unit 33 performs a process to acquire field-of-view information to identify the field of view of the user 90 who is wearing the HMD 20. The field of view of the user 90 refers to a scene as seen through the eyes of the user 90 in a state in which the user 90 is wearing the HMD 20. According to the present embodiment, the field of view of the user 90 refers to the scene as seen through the eyes of the user 90 through the display unit 21 that is the lens portion of the glasses. For example, the field-of-view information acquiring unit 33 acquires the field-of-view information of the user 90 from the image captured by the camera 22. According to the present embodiment, for example, as shown in FIG. 3 and the like, an imaging area 221 of the camera 22 and the area of the display unit 21 are considered to be a field of view 91 of the user 90.

The monitoring target identifying unit 34 shown in FIG. 2 performs a process to identify the robot 11 (also referred to, hereafter, as the monitoring target 11) present within the field of view 91 of the user 90 based on the field-of-view information acquired by the field-of-view information acquiring unit 33. For example, the monitoring target identifying unit 34 identifies the monitoring target 11 in the following manner. That is, for example, a marker for identifying the individual monitoring target is attached to each monitoring target 11. The monitoring target identifying unit 34 then identifies each monitoring target 11 by recognizing the marker attached to the monitoring target 11 based on the image captured by the camera 22.

As shown in FIG. 3, when the monitoring target information regarding the monitoring target 11 captured within the field of view 91 of the user 90 is present, that is, when the monitoring target information acquiring unit 32 has acquired the monitoring target information regarding the monitoring target 11 captured within the field of view 91 of the user 90, the display control unit 35 displays a symbol display 41 within the field of view 91 of the user 90. The symbol display 41 indicates that the monitoring target information is present. For example, in the example in FIG. 3, each of the two robots 111 and 112 captured within the field of view 91 has the monitoring target information. In this case, the display control unit 35 displays two symbol displays 411 and 412 corresponding to the robots 111 and 112 within the field of view 91.

In the description below, when differentiation is made between the two symbol displays 411 and 412, the symbol display corresponding to the first robot 111 is referred to as a first symbol display 411. The symbol display corresponding to the second robot 112 is referred to as a second symbol display 412. The display control unit 35 displays the symbol display 41 near the monitoring target 11 as a graphic figure that appears to balloon out from the monitoring target 11. In addition, in cases in which a plurality of symbol displays 41 are simultaneously displayed, the display control unit 35 displays the symbol displays 41 such as not to overlap each other.

Here, the symbol display 41 is a display that indicates that the monitoring target information related to the monitoring target 11 is present. To minimize the amount of information provided to the user, the symbol display 41 is configured by a graphic symbol that does not have a character string of three or more characters. According to the present embodiment, the symbol display 41 adopts a mark that indicates general danger as prescribed, for example, by ISO 7010. That is, for example, the symbol display 41 is configured by a graphic symbol in which a symbol “!” is enclosed in a graphic figure of a speech bubble. The symbol display 41 is not limited to this graphic symbol. For example, the symbol display 41 may be configured to have a character string composed of a single character or two or more characters.

As shown in FIG. 3 and the like, an aim display 51 is set within the field of view 91 of the user 90. The aim display 51 virtually indicates a line of sight of the user 90 within the field of view 91 of the user 90. According to the present embodiment, the aim display 51 is set in a specific location within the field of view 91, such as in a center portion in an up/down direction and a left/right direction of the field of view 91. For example, the aim display 51 is configured by a visible graphic figure of a cross.

The aim display 51 is relatively fixed in relation to the orientation of the head portion of the user 90. That is, the position of the aim display 51 within the field of view 91 does not change, even should the orientation of the head portion of the user 90 change. For example, the aim display 51 may be physically printed onto the display unit 21 in advance. Alternatively, the aim display 51 may be displayed in the display unit 21 by the display control unit 35. Furthermore, as long as the aim display 51 is prescribed to a specific location within the field of view 91, the aim display 51 is not necessarily required to be visibly displayed within the field of view 91.

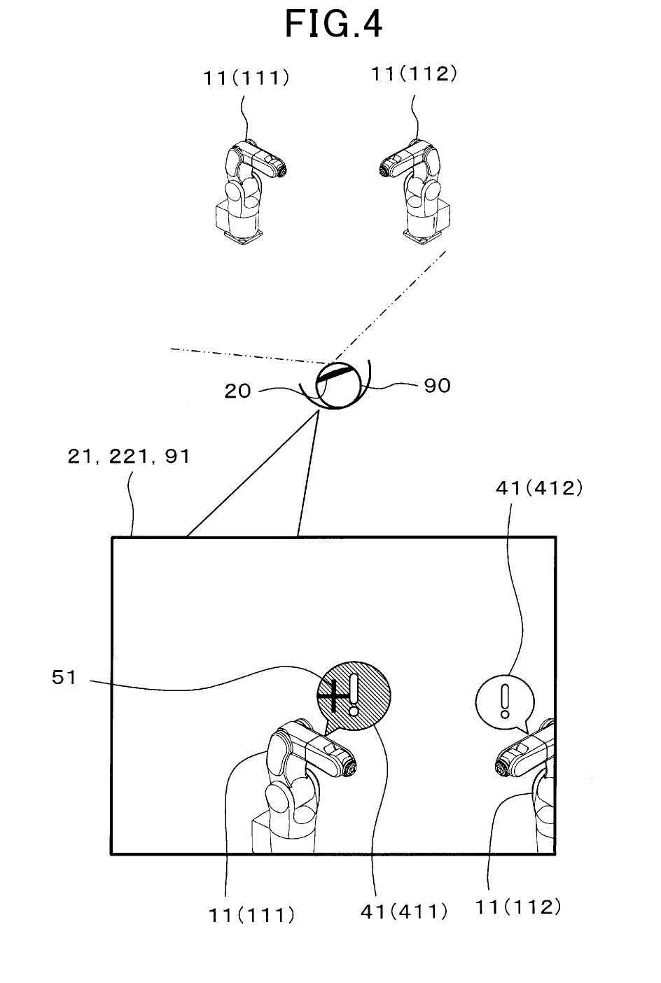

When the user 90 wishes to confirm the monitoring target information 421 of the first robot 111, for example, among the robots 111 and 112 captured within the field of view 91, as shown in FIG. 4, the user 90 orients their line of sight towards the first symbol display 411 corresponding to the first robot 111 and moves the field of view 91 such that the aim display 51 and the first symbol display 411 overlap within the field of view 91. Then, the display control unit 35 first displays the first symbol display 411 that overlaps with the aim display 51 in a manner differing from that when the first symbol display 411 does not overlap with the aim display 51, such by changing color or size. As a result, the user 90 can know that the aim display 51 has captured the first symbol display 411.

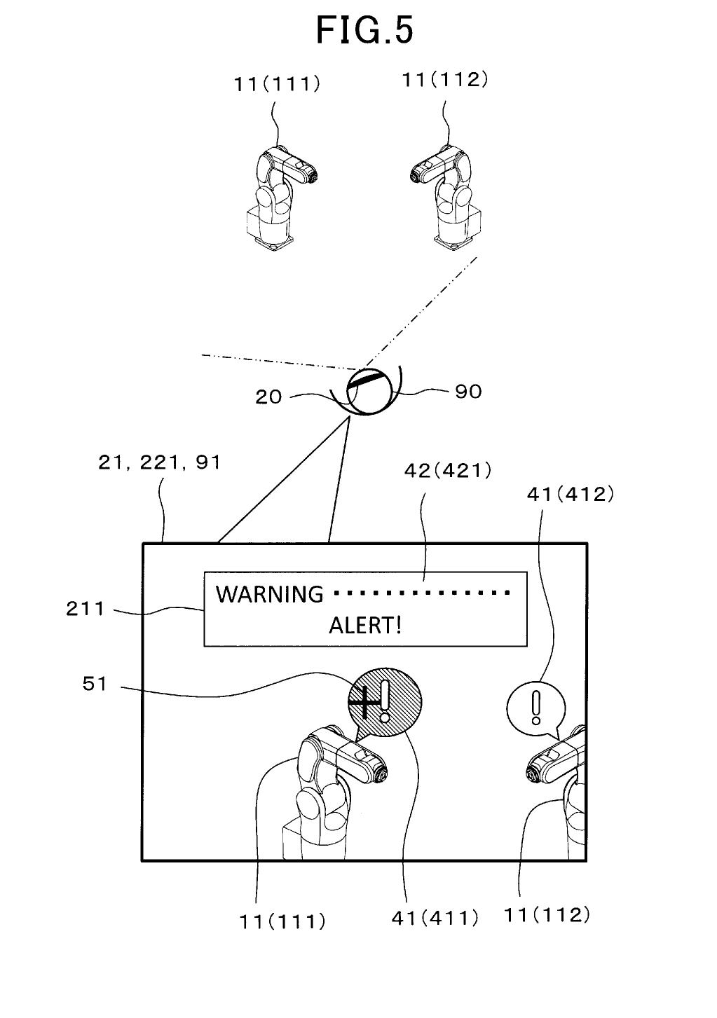

After a predetermined period elapses from when the aim display 51 starts to overlap the first symbol display 411, as shown in FIG. 5, the display control unit 35 displays the first monitoring target information 421 corresponding to the first robot 111 within the field of view 91. As a result, the user 90 can confirm the first monitoring target information 421 related to the first robot 111. In this case, for example, the predetermined period is from about one to three seconds. However, the predetermined period may be arbitrarily set by the user.

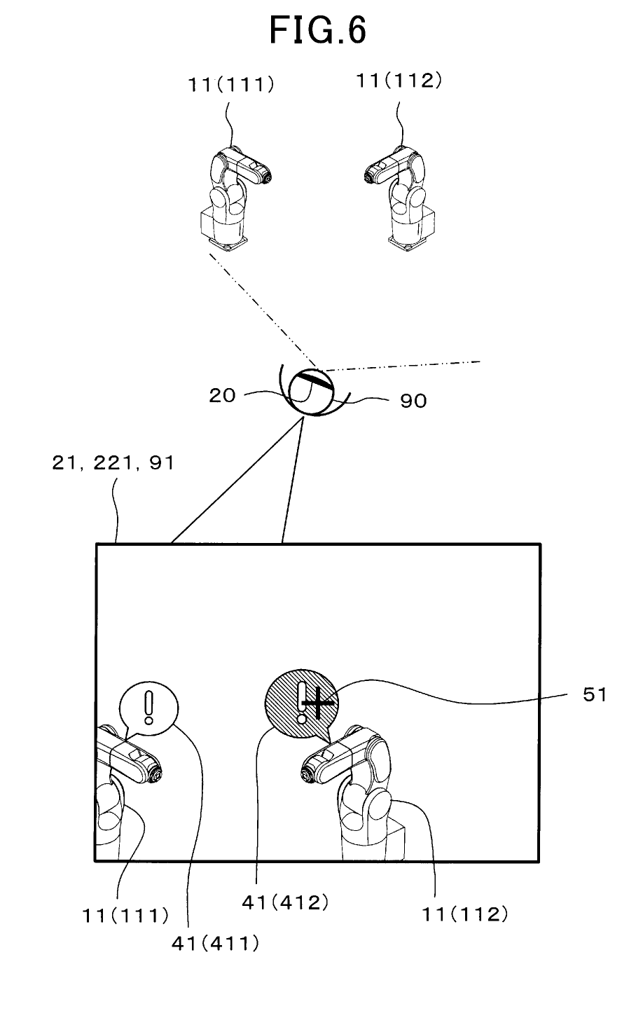

In a similar manner, in the state shown in FIG. 3, when the user 90 wishes to confirm the monitoring target information 422 of the second robot 112, among the robots 111 and 112 captured within the field of view 91, as shown in FIG. 6, the user 90 orients their line of sight towards the second symbol display 412 corresponding to the second robot 112 and moves the field of view 91 such that the aim display 51 and the second symbol display 412 overlap within the field of view 91. Then, the display control unit 35 first displays the second symbol display 412 that overlaps with the aim display 51 in a manner differing from that when the second symbol display 412 does not overlap with the aim display 51, such by changing color or size. As a result, the user 90 can know that the aim display 51 has captured the second symbol display 412.

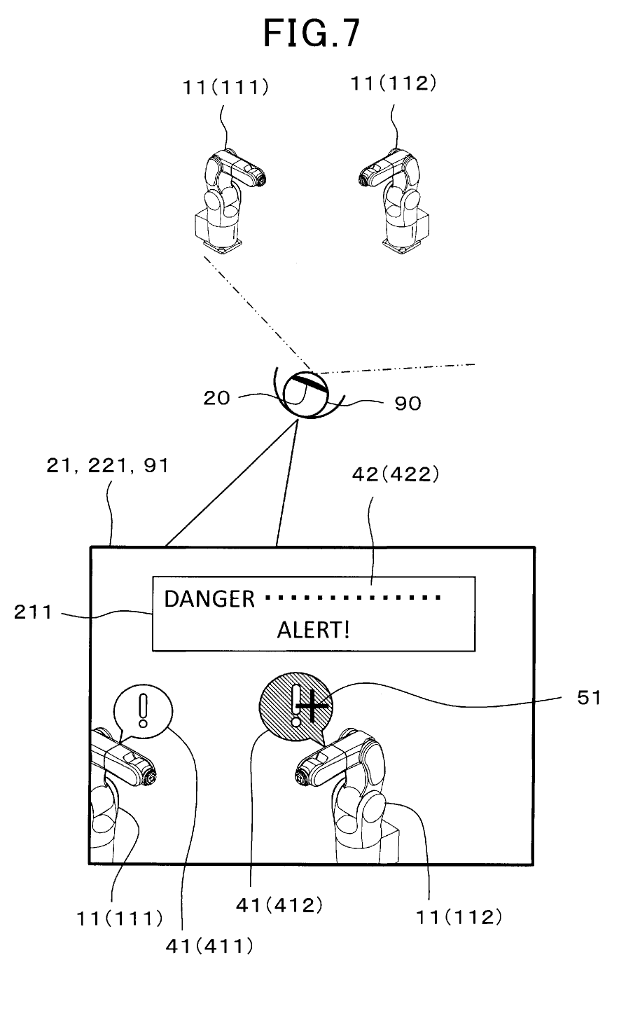

After a predetermined period, such as from about one to three seconds as described above, elapses from when the aim display 51 starts to overlap the second symbol display 412, as shown in FIG. 7, the display control unit 35 displays the second monitoring target information 422 corresponding to the second robot 112 within the field of view 91. As a result, in a manner similar to that of the first monitoring target information 421 described above, the user 90 can confirm the second monitoring target information 422 related to the second robot 112.

When the monitoring target information 42 is displayed, as shown in FIGS. 5 and 7, the display control unit 35 displays a non-transparent display area 211 within the field of view 91 of the user 90. The display control unit 35 then displays character information, as well as numeric, graphic, and symbolic information, and the like configuring the monitoring target information 42 within the non-transparent display area 211. According to the present embodiment, for example, the display control unit 35 displays the inside of the display area 211 so as to be non-transparent in a color opposing the color of the monitoring target information 42. As a result, the actual scene in the background of the display area 211 is covered and hidden. Consequently, the monitoring target information 42 displayed within the display area 211 can be prevented from blending into the actual scene in the background of the display area 211. Therefore, the monitoring target information 42 becomes more visible. The display area 211 is provided to display the monitoring target information 42. Therefore, the display control unit 36 is not necessarily required to display a border that marks the display area 211 or to display the inside of the display area 211 in the display unit 21.

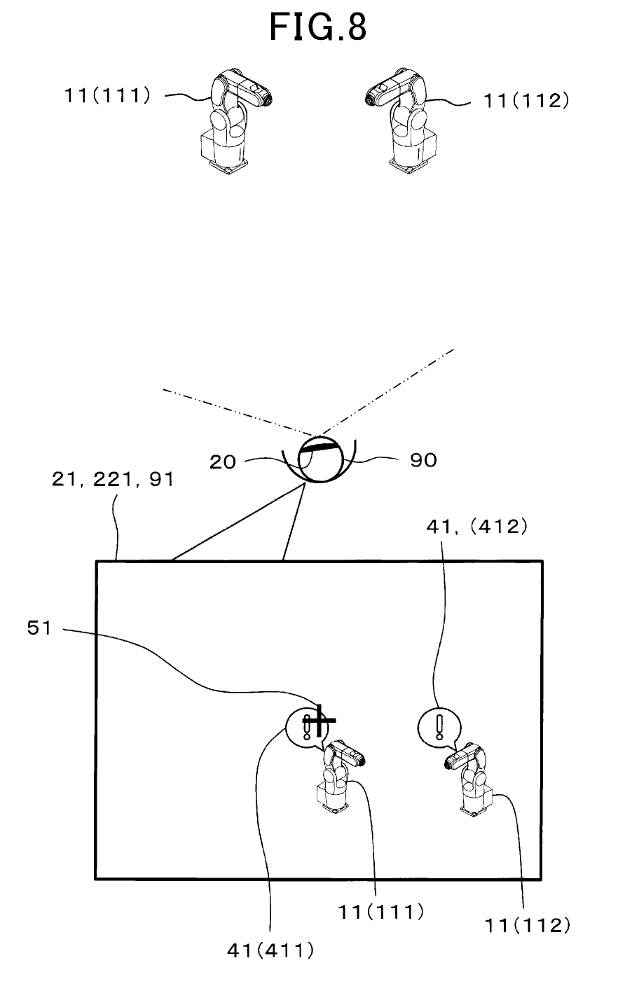

In addition, as shown in FIG. 8, when the distance from the robot 11 within the field of view 91 to the user 90 that has been acquired by the monitoring target information acquiring unit 32 is equal to or greater than a predetermined distance, the display control unit 35 performs the following process. That is, in this case, even when the aim display 51 overlaps the first symbol display 411 corresponding to the first robot 11 that is at a far-off distance, for example, the monitoring target information regarding the first robot 111 that corresponds to the first symbol display 411 overlapping with the aim display 51 is not displayed within the field of view 91 of the user 90.

Instead of the above-described process, the display control unit 35 may perform the following process. That is, when the distance from the robot 11 to the user 90 is equal to or greater than a predetermined distance, the display control unit 35 may not display the symbol display 41 of the robot 11 within the field of view 91 of the user 90 in the first place.

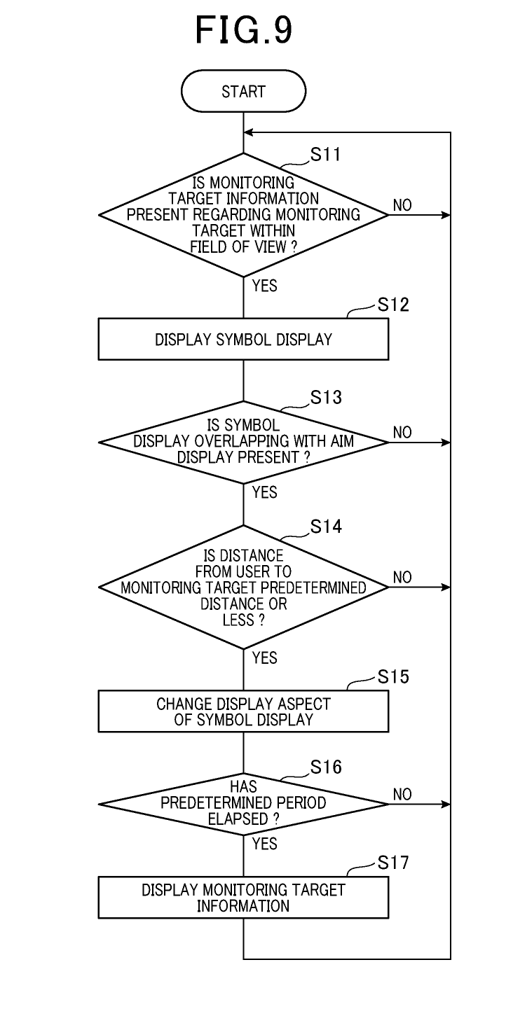

Next, the flow of control performed by the control unit 31 of the display control apparatus 30 will be described with referenced to FIG. 9 as well. When the control unit 31 runs the information display program, the control unit 31 performs the flow of control in FIG. 9. First, at step S11, the control unit 31 determines whether or not the monitoring target information 42 to be displayed within the field of view 91 regarding the monitoring target 11 captured within the field of view 91 is present by the processes performed by the monitoring target information acquiring unit 32, the field-of-view information acquiring unit 33, and the monitoring target identifying unit 34. For example, a case in which the monitoring target information 42 regarding the monitoring target 11 is not acquired is when the power of the monitoring target 11 is turned off and operation is stopped, that is, when there is no danger in approaching the monitoring target 11.

When determined that the monitoring target information 42 to be displayed within the field of view 91 regarding the monitoring target 11 captured within the field of view 91 is not present (NO at step S11), the control unit 31 returns the process to step S11. Meanwhile, when determined that the monitoring target information 42 to be displayed within the field of view 91 regarding the monitoring target 11 captured within the field of view 91 is present (YES at step S11), the control unit 31 shifts the process to step S12.

Next, the control unit 31 displays the symbol display 41 within the field of view 91 regarding the monitoring target 11 captured within the field of view 91 by the process performed by the display control unit 35. Next, at step S13, the control unit 31 determines whether or not a symbol display 41 that overlaps with the aim display 51 is present within the field of view 91. When determined that the aim display 51 does not overlap any of the symbol displays 41 displayed within the field of view 91 (NO at step S13), the control unit 31 returns the process to step S11, and repeatedly performs step S11 and subsequent steps. Meanwhile, when determined that the aim display 51 overlaps any of the symbol displays 41 displayed within the field of view 91 (YES at step S13), the control unit 31 shifts the process to step S14. At step S14, the control unit 31 acquires the distance from the monitoring target 11 that corresponds to the symbol display 41 overlapping with the aim display 51 to the user 90, by the process performed by the monitoring target information acquiring unit 32. Then, the control unit 31 determines whether or not the distance from the monitoring target 11 that corresponds to the symbol display 41 overlapping with the aim display 51 to the user 90 is equal to or less than a predetermined distance by the process performed by the display control unit 35. When determined that the distance from the monitoring target 11 to the user 90 exceeds the predetermined distance (NO at step S14), the control unit 31 returns the process to step S11, and repeatedly performs step S11 and subsequent steps.

Meanwhile, when determined that the distance from the monitoring target 11 to the user 90 is equal to or less than the predetermined distance (YES at step S14), the control unit 31 shifts the process to step S15. At step S15, the control unit 31 displays the symbol display 41 that overlaps with the aim display 51 in a manner differing from that when the symbol display 41 does not overlap with the aim display 51 by the process performed by the display control unit 35. For example, the control unit 31 changes the color or size of the symbol display 41.

Next, at step S16, the control unit 31 determines whether or not a predetermined period has elapsed from when step S15 is performed, that is, whether or not the aim display 51 and the same symbol display 41 have continuously overlapped for the predetermined period. When determined that the aim display 51 and the same symbol display 41 have not continuously overlapped for the predetermined period (NO at step S16), the control unit 31 returns the process to step S11, and repeatedly performs step S11 and subsequent steps. Meanwhile, when determined that the aim display 51 and the same symbol display 41 have continuously overlapped for the predetermined period (YES at step S16), the control unit 31 shifts the process to step S17. Then, the control unit 31 displays the monitoring target information 42 that corresponds to the symbol display 41 overlapping with the aim display 51 within the field of view 91 of the user 90 by the process performed by the display control unit 35.

Then, the control unit 31 returns the process to step S11, and repeatedly performs step S11 and subsequent steps. For example, the display of the monitoring target information 42 is continued until the aim display 51 is removed from the symbol display 41 that corresponds to the monitoring target information 42 currently being displayed within the field of view 91 or the elapse of a predetermined period set in advance from when the monitoring target information 42 is displayed.

According to the embodiment described above, in the information display system 10, when the monitoring target information 42 regarding the monitoring target 11 captured within the field of view 91 of the user 90 is present, the display control unit 35 displays the symbol display 41 within the field of view 91 of the user 90. The symbol display 41 indicates that the monitoring target information 42 is present. Then, when the aim display 51 set within the field of view 91 of the user 90 overlaps the symbol display 41 within the field of view 91 of the user 90, the display control unit 35 displays the monitoring target information 42 corresponding to the symbol display 41 within the field of view 91 of the user 90.

As a result, the user 90 can confirm whether or not the monitoring target information 42 regarding the monitoring target 11 captured within their field of view 91 is present by confirming the symbol display 41 displayed within the field of view 91. In addition, the user 90 can display the monitoring target information 42 corresponding to the symbol display 41 within the field of view 91 by changing the orientation of their head, that is, their line of sight and moving the field of view 91, and thereby overlapping the aim display 51 set within the field of view 91 with the symbol display 41 within the field of view 91. Therefore, even when a plurality of monitoring targets 11 are captured within the field of view 91, numerous pieces of monitoring target information 42 are not simultaneously displayed within the field of view 91. The field of view 91 of the user 90 is not obstructed. As a result, even when a plurality of monitoring targets 11 are captured within the field of view 91, the monitoring target information 42 displayed within the field of view 91 can be prevented from blocking the field of view 91. Consequently, information presentation in which the field of view 91 of the user 90 is not easily obstructed can be achieved.

In addition, the display control unit 35 visibly displays the aim display 51 within the field of view 91 of the user 90. Therefore, the user 90 can overlap the aim display 51 and the symbol display 41 while visually confirming the aim display 51 and the symbol display 41. As a result, the user 90 can easily overlap the aim display 51 and the symbol display 41. Consequently, operability is improved.

Here, a following case can be supposed. That is, for example, the user 90 may move the field of view 91 in accompaniment with an ordinary operation, rather than moving the field of view 91 to view the monitoring target information 42. The aim display 51 and the symbol display 41 may overlap within the field of view 91, counter to the intentions of the user 90. In this case, when the user 90 moves the field of view 91 during an ordinary operation, should the monitoring target information 42 be displayed within the field of view 91, counter to the intentions of the user 90, simply because the aim display 51 passes over and temporarily overlaps the symbol display 41 within the field of view 91, the field of view 91 is instead obstructed. Therefore, according to the present embodiment, the display control unit 35 displays the monitoring target information 42 within the field of view 91 after a predetermined period from about one to three seconds, for example, elapses from when the aim display 51 starts to overlap the symbol display 41.

As a result, the monitoring target information 42 is displayed within the field of view 91 only when the user 90 overlaps and views the aim display 51 and the symbol display 41 for a predetermined period or longer, that is, the user 90 indicates a clear intent to overlap the aim display 51 and the symbol display 41. In other words, as a result, the monitoring target information 42 being displayed within the field of view 91 simply because the aim display 51 passes over and temporarily overlaps the symbol display 41 within the field of view 91 can be prevented. Consequently, a safer information presentation in which the field of view 91 of the user 90 is further less easily obstructed can be achieved.

In addition, when the aim display 51 overlaps the symbol display 41 within the field of view 91 of the user 90, the display control unit 35 displays the symbol display 41 that overlaps with the aim display 51 in a manner differing from that of the symbol display 41 that does not overlap with the aim display 51. As a result, the user 90 can confirm whether or not the aim display 51 overlaps the symbol display 41 by seeing whether or not the display aspect of the symbol display 41 has changed.

That is, for example, as shown in FIG. 4 or 6, under an assumption of a state before the monitoring target information 42 is displayed, the user 90 can visually confirm whether or not the aim display 51 overlaps the symbol display 41 by seeing a change in the display aspect of the symbol display 41. In addition, in cases in which a plurality of monitoring targets 11 are captured within the field of view 91, the user 90 can visually confirm the symbol display 41 corresponding to the monitoring target information 42 that the user 90 wishes to view, by seeing the symbol display 41 of which the display aspect has changed.

Furthermore, as shown in FIG. 5 or 7, under an assumption of a state after the monitoring target information 42 is displayed, in cases in which a plurality of monitoring targets 11 are captured within the field of view 91, such as in the example in FIG. 5, the first symbol display 411 that corresponds to the first monitoring target information 421 displayed within the field of view 91 is displayed in a manner differing from that of the second symbol display 412 of which the second monitoring target information 422 is not displayed.

Therefore, even in cases in which a plurality of monitoring targets 11 are captured within the field of view 91 and a plurality of symbol displays 41 are displayed within the field of view 91, the user 90 can confirm, at a glance, the symbol display 41 within the field of view 91 that corresponds to the monitoring target information 42 currently being displayed, by seeing the symbol display 41 that is being displayed in an aspect that differs from that of the other symbol displays 41. Consequently, confirmation by the user is facilitated and an even safer information presentation can be achieved.

Furthermore, the display control unit 35 displays the non-transparent display area 211 within the field of view 91 of the user 90 and displays the monitoring target information 42 within the display area 211. Therefore, as a result of the monitoring target information 42 being displayed within the non-transparent display area 211, the monitoring target information 42 that is displayed within the display area 211 can be prevented from blending with the actual scene in the background of the display area 211. As a result, the monitoring target information 42 can be made more easily visible. Consequently, an even safer information presentation can be achieved.

Here, for example, when the user 90 moves to another location, the user 90 often looks over a distance to where the destination is located. As shown in FIG. 8, for example, the monitoring target 11 that is at a far-off distance appears small within the field of view 91. Therefore, while moving to another location, the user 90 is unlikely to be watching the monitoring target 11 itself. However, a following case may be supposed. That is, when the user 90 who is moving while looking towards the destination moves their line of sight, the aim display 51 may inadvertently overlap the symbol display 41 corresponding to a far-off monitoring target 11. In this case, when the monitoring target information 42 is displayed within the field of view 91 counter to the intentions of the user 90, the field of view 91 of the user 90 who is moving becomes blocked. Therefore, decrease in safety instead becomes a concern.

Therefore, according to the present embodiment, regarding the monitoring target 11 that is separated from the user 90 by a predetermined distance or more, among the monitoring targets 11 captured within the field of view 91 of the user 90, the display control unit 35 does not display the monitoring target information 42 within the field of view of the user 90, even when the aim display 51 overlaps the symbol display 41. As a result, as shown in FIG. 8, even when the aim display 51 coincidentally overlaps the symbol display 41 corresponding to the monitoring target 11 that is at a far-off distance within the field of view 91 of the user 90 who is moving to another location, the monitoring target information 42 corresponding to the symbol display 41 is not displayed within the field of view 91.

As a result, for example, even when the user 90 who is moving to another location captures the monitoring target 11 at a far-off distance within the field of view 91, the monitoring target information 42 regarding the far-off monitoring target 11 is not displayed. Therefore, blocking of the field of view 91 of the user 90 who is moving to another location can be reduced. Consequently, safety can be further improved.

In addition, the display control unit 35 may not display the symbol display 41 within the field of view 91 of the user 90 regarding the monitoring target 11 that is separated from the user 90 by a predetermined distance or more, among the monitoring targets 11 captured within the field of view 91 of the user 90. As a result of this configuration as well, in manner similar to that described above, for example, even when the user 90 who is moving to another location captures the monitoring target 11 at a far-off distance within the field of view 91, the monitoring target information 42 regarding the far-off monitoring target 11 is not displayed. Therefore, blocking of the field of view 91 of the user 90 who is moving to another location can be reduced. Consequently, safety can be further improved.

The embodiment of the present disclosure is not limited to the aspects described above or in the drawings. Various modifications and expansions are possible without departing from the spirit of the present disclosure.

For example, the control unit 31, the monitoring target information acquiring unit 32, the field-of-view information acquiring unit 33, the monitoring target identifying unit 34, and the display control unit 35 may be provided so as to be separately dispersed on either of the safety apparatus 13 side and the HMD 20 side.

The robot 11 is not limited to that which is fixed at a specific location. For example, the robot 11 may be a mobile robot. Moreover, the monitoring target 11 is not limited to a robot. For example, the monitoring target may be a manned carrier, such as a forklift, that is driven by a person, or a mobile object, such as an unmanned carrier, that automatically travels.

What is claimed is:

1. An information display system comprising:
a wearable display that is worn by a user and displays information within a field of view of the user;
a monitoring target information acquiring unit that acquires monitoring target information that is information related to a monitoring target;
a field-of-view information acquiring unit that acquires field-of-view information for identifying the field of view of the user;
a monitoring target identifying unit that identifies the monitoring target present within the field of view of the user based on the field-of-view information acquired by the field-of-view information acquiring unit; and
a display control unit that displays, within the field of view of the user, a symbol display that indicates that the monitoring target information is present when the monitoring target information regarding the monitoring target captured within the field of view of the user is present, and displays, within the field of view of the user, the monitoring target information corresponding to the symbol display when an aim display set within the field of view of the user overlaps the symbol display within the field of view of the user.

2. The information display system according to claim 1, wherein:
the display control unit visibly displays the aim display within the field of view of the user.

3. The information display system according to claim 2, wherein:
the display control unit displays the monitoring target information after elapse of a predetermined period from when the aim display starts to overlap the symbol display.

4. The information display system according to claim 3, wherein:
the display control unit displays, when the aim display overlaps the symbol display within the field of view of the user, the symbol display that overlaps the aim display in a manner differing from that when the aim display does not overlap the symbol display.

5. The information display system according to claim 4, wherein:
the display control unit displays a non-transparent display area within the field of view of the user and displays the monitoring target information within the display area.

6. The information display system according to claim 5, wherein:
the display control unit
does not display the monitoring target information within the field of view of the user regarding the monitoring target that is separated from the user by a predetermined distance or more, among the monitoring targets captured within the field of view of the user, even when the aim display overlaps the symbol display, or
does not display the symbol display within the field of view of the user regarding the monitoring target that is separated from the user by a predetermined distance or more, among the monitoring targets captured within the field of view of the user.

7. The information display system according to claim 1, wherein:
the display control unit displays the monitoring target information after elapse of a predetermined period from when the aim display starts to overlap the symbol display.

8. The information display system according to claim 1, wherein:
the display control unit displays, when the aim display overlaps the symbol display within the field of view of the user, the symbol display that overlaps the aim display in a manner differing from that when the aim display does not overlap the symbol display.

9. The information display system according to claim 1, wherein:
the display control unit displays a non-transparent display area within the field of view of the user and displays the monitoring target information within the display area.

10. The information display system according to claim 1, wherein:
the display control unit
does not display the monitoring target information within the field of view of the user regarding the monitoring target that is separated from the user by a predetermined distance or more, among the monitoring targets captured within the field of view of the user, even when the aim display overlaps the symbol display, or
does not display the symbol display within the field of view of the user regarding the monitoring target that is separated from the user by a predetermined distance or more, among the monitoring targets captured within the field of view of the user.
